(19) United States
(12) Patent Application Publication
(10) Pub. No.: US 2022/0328810 A1
(43) Pub. Date: Oct. 13, 2022

(54) POSITIVE ELECTRODE AND SECONDARY BATTERY INCLUDING POSITIVE ELECTRODE

(71) Applicant: Prime Planet Energy & Solutions, Inc., Tokyo (JP)

(72) Inventors: Keiichi TAKAHASHI, Nishinomiya-shi (JP); Ryo HANAZAKI, Kobe-shi (JP); Akira TSUJIKO, Kobe-shi (JP)

(21) Appl. No.: 17/715,953

(22) Filed: Apr. 8, 2022

(30) Foreign Application Priority Data
Apr. 9, 2021 (JP) 2021-066392

(51) Int. Cl. H01M 4/36; H01M 4/525; H01M 10/0525

(52) U.S. Cl. CPC H01M 4/366; H01M 4/525; H01M 10/0525; H01M 2004/021

(57) ABSTRACT

A positive electrode includes a current collector, and an active material layer provided on the current collector. The active material layer has a first layer located on the current collector side and a second layer located on a surface layer side of the active material layer. A proportion of a thickness of the second layer to a total thickness of the first and second layers is from 0.20 to 0.80. When each specific capacity of a potential flat portion near 4.2 V in a charging voltage curve is measured for the first and second layers, the above specific capacity of the second layer is larger than that of the first layer. The above specific capacity of the second layer is greater than 17 mAh/g and at most 30 mAh/g. The above specific capacity of the first layer is from 2 mAh/g to 17 mAh/g.

### BACKGROUND OF THE INVENTION

### 1. Field of the Invention

The present disclosure relates to a positive electrode. The present disclosure also relates to a secondary battery including the positive electrode. The present application claims priority to Japanese Patent Application No. 2021-066392, filed on Apr. 9, 2021, the contents of which are incorporated in their entirety in the present specification by reference.

### 2. Description of the Related Art

In recent years, secondary batteries such as lithium ion secondary batteries have been suitably used, for example, as portable power sources for personal computers, portable terminals, and the like and power sources for driving vehicles such as battery-powered electric vehicles (BEV), hybrid electric vehicles (HEV), and plug-in hybrid electric vehicles (PHEV).

In general, a positive electrode of a secondary battery has a configuration in which a positive electrode active material layer containing a positive electrode active material is supported on a positive electrode current collector. A technique in which a positive electrode active material layer in a positive electrode has a multilayer structure and different positive electrode active materials are used in each layer is known conventionally. For example, Japanese Patent Application Publication No. 2018-198132 discloses a technique in which output density and energy density of a lithium ion secondary battery are improved by using a high-capacity positive electrode active material having a high content of Ni in a lower layer (that is, a layer on a positive electrode current collector side) and using a high-output positive electrode active material having a high content of Co in an upper layer (that is a layer on a surface layer side) in a positive electrode active material layer having a two-layer structure.

### SUMMARY OF THE INVENTION

However, the present inventors have conducted extensive studies, and as a result, have found that the above-described positive electrode of the conventional art has a problem of causing capacity deterioration in a case where the secondary battery including the positive electrode is repeatedly charged and discharged. That is, they have found that there is a problem that the cycle characteristics are insufficient. On the other hand, it is desirable for the secondary battery to generate less heat in a case where a large internal short circuit occurs such as when a metallic article penetrates an electrode body. That is, it is desirable for the secondary battery to have excellent internal short circuit resistance.

Therefore, an object of the present disclosure is to provide a positive electrode which includes a positive electrode active material layer having a multilayer structure and can impart excellent cycle characteristics and internal short circuit resistance to a secondary battery.

The positive electrode disclosed herein includes: a positive electrode current collector; and a positive electrode active material layer provided on the positive electrode current collector. The positive electrode active material layer has a first layer located on the positive electrode current collector side and a second layer located on a surface layer side of the positive electrode active material layer. A proportion of a thickness of the second layer to a total thickness of the first layer and the second layer is 0.20 or more and 0.80 or less. When each specific capacity of a potential flat portion near 4.2 V (vs Li/Li⁺) in a charging voltage curve is measured for the first layer and the second layer, the specific capacity of the potential flat portion of the second layer is larger than that of the first layer. The specific capacity of the potential flat portion of the second layer is greater than 17 mAh/g and at most 30 mAh/g. The specific capacity of the potential flat portion of the first layer is 2 mAh/g or more and 17 mAh/g or less. According to such a configuration, it is possible to provide a positive electrode which includes a positive electrode active material layer having a multilayer structure and can impart excellent cycle characteristics and internal short circuit resistance to a secondary battery.

In a desired aspect of the positive electrode disclosed herein, the first layer and the second layer each contain a positive electrode active material. Each of the positive electrode active materials contained in the first layer and the second layer is lithium composite oxides having a content of Ni of 75 mol % or more with respect to metal atoms other than lithium. According to such a configuration, it is easy to adjust the specific capacity of the potential flat portion near 4.2 V (for example, in a region of 4.18 V to 4.22 V) in the charging voltage curve and possible to increase the capacity of the positive electrode, which is advantageous.

In a desired aspect of the positive electrode disclosed herein, the first layer contains a Ti-doped positive electrode active material, and the second layer contains a Zr-doped positive electrode active material. According to such a configuration, it is easy to adjust the specific capacity of the potential flat portion near 4.2 V in the charging voltage curve, which is advantageous.

In a desired aspect of the positive electrode disclosed herein, the first layer or the second layer contains a positive electrode active material in a form of single particles. According to such a configuration, it is easy to adjust the specific capacity of the potential flat portion near 4.2 V in the charging voltage curve and possible to further suppress capacity deterioration, which is advantageous.

In a desired aspect of the positive electrode disclosed herein, the above-mentioned thickness proportion is 0.23 or more and 0.50 or less. According to such a configuration, it is possible to impart superior cycle characteristics and internal short circuit resistance to a secondary battery.

From another aspect, a secondary battery disclosed herein includes: the above-described positive electrode; a negative electrode; and an electrolyte. According to such a configuration, it is possible to provide a secondary battery having excellent cycle characteristics and internal short circuit resistance.

### BRIEF DESCRIPTION OF THE DRAWINGS

FIG. 1 is a cross-sectional view schematically showing a structure of a positive electrode according to one embodiment of the present disclosure;

FIG. 2 is a graph showing a charge/discharge curve in a case where a secondary-particle-like positive electrode active material in which 0.5 atomic % of ZrO₂ is added to LiNi_{0.8}Co_{0.1}Mn_{0.1}O₂ is used;

FIG. 3 is a graph showing a charge/discharge curve in a case where a secondary-particle-like positive electrode active material in which 0.5 atomic % of WO₃ is added to LiNi_{0.8}Co_{0.1}Mn_{0.1}O₂ is used;

FIG. 4 is a graph showing a charge/discharge curve in a case where a secondary-particle-like positive electrode active material in which 3 atomic % of TiO₂ is added to LiNi_{0.8}Co_{0.1}Mn_{0.1}O₂ is used;

FIG. 5 is a graph showing a charge/discharge curve in a case where a secondary-particle-like positive electrode active material in which 1 atomic % of Nb₂O₅ is added to LiNi_{0.8}Co_{0.1}Mn_{0.1}O₂ is used;

FIG. 6 is a graph showing a charge/discharge curve in a case where a positive electrode active material which is single-particle-like LiNi_{0.8}Co_{0.1}Mn_{0.1}O₂ is used;

FIG. 7 is a cross-sectional view schematically showing an internal structure of a lithium ion secondary battery according to one embodiment of the present disclosure; and

FIG. 8 is a schematic exploded view showing a wound electrode body of a lithium ion secondary battery according to one embodiment of the present disclosure.

### DESCRIPTION OF THE PREFERRED EMBODIMENTS

Hereinafter, embodiments according to the present disclosure will be described with reference to the drawings. Matters other than those mentioned in the present specification and required for implementation of the present disclosure can be understood as design matters for those skilled in the art based on the conventional art in the pertinent field. The present disclosure can be implemented based on the content disclosed in the present specification and common technical knowledge in the pertinent field. In addition, in the following drawings, members and portions exhibiting the same action are given of the same reference numerals for description. In addition, dimensional relationships (between a length, a width, a thickness, and the like) in each drawing do not reflect actual dimensional relationships.

It should be noted that the term “secondary battery” in the present specification refers to a power storage device that can be repeatedly charged and discharged, and the term includes so-called storage batteries and power storage elements such as an electric double-layer capacitor. In addition, the term “lithium ion secondary battery” in the present specification refers to a secondary battery in which lithium ions are used as charge carriers and charging and discharging are realized by movement of charges accompanying the lithium ions between positive and negative electrodes.

Positive Electrode

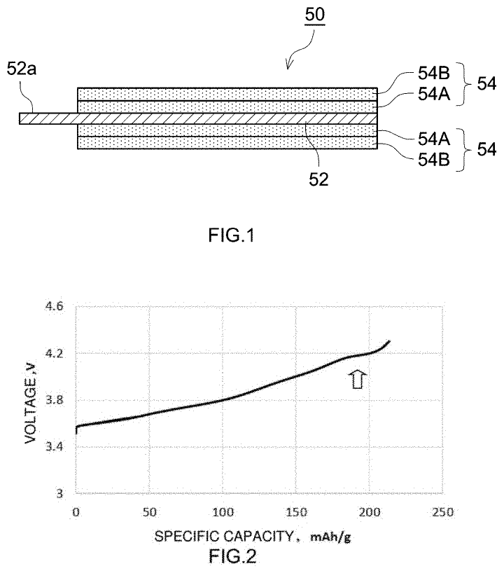

FIG. 1 shows a positive electrode 50 according to the present embodiment as an example of the positive electrode disclosed herein. The positive electrode 50 according to the present embodiment includes, as shown in the drawing, a positive electrode current collector 52 and a positive electrode active material layer 54 supported on the positive electrode current collector 52. The positive electrode active material layers 54 are provided on both surfaces of the positive electrode current collector 52 in the illustrated example, but the positive electrode active material layer 54 may be provided on a single surface thereof. The positive electrode active material layers 54 are desirably provided on both surfaces of the positive electrode current collector 52.

As shown in the illustrated example, the positive electrode 50 may have, on at least one end, a positive electrode active material layer non-formed portion 52a in which no positive electrode active material layer 54 is formed and the positive electrode current collector 52 is exposed. The positive electrode active material layer non-formed portion 52a functions as a current-collecting unit (particularly, a current-collecting tab).

As the positive electrode current collector 52, a foil-like or sheet-like body made of a metal such as aluminum, nickel, titanium, or stainless steel can be used, and aluminum foil is desirably used. When aluminum foil is used as the positive electrode current collector 52, its thickness is not particularly limited, but is, for example, 5 μm or more and 35 μm or less and desirably 7 μm or more and 20 μm or less.

As shown in the drawing, each positive electrode active material layer 54 includes a first layer (hereinafter, also referred to as “lower layer”) 54A located on the positive electrode current collector 52 side and a second layer (hereinafter, also referred to as “upper layer”) 54B located on a surface layer side thereof. Accordingly, the positive electrode active material layer 54 has a multilayer structure. In the present embodiment, both positive electrode active material layers 54 (that is, those on both surfaces of the positive electrode current collector 52) have these layers. However, only one positive electrode active material layer 54 (that is, one on a single surface of the positive electrode current collector 52) may have a multilayer structure including the lower layer 54A and the upper layer 54B.

In the present embodiment, in a case where charging voltage curves are acquired for the lower layer 54A and the upper layer 54B, the values of the specific capacities of potential flat portions near 4.2 V (vs Li/Li⁺) (the notation “V” in the present specification represents a metallic Li reference potential, unless otherwise specified) in the charging voltage curves are different therebetween. Specifically, the specific capacity (that is, the specific capacity of the above-described potential flat portion of the upper layer 54B) of the potential flat portion near 4.2 V in the charging voltage curve for the upper layer 54B is larger than the specific capacity (that is, the specific capacity of the above-described potential flat portion of the lower layer 54A) of the potential flat portion near 4.2 V in the charging voltage curve for the lower layer 54A. In addition, the specific capacity of the above-described potential flat portion of the upper layer 54B is greater than 17 mAh/g and at most 30 mAh/g. On the other hand, the specific capacity of the above-described potential flat portion of the lower layer 54A is 2 mAh/g or more and 17 mAh/g or less.

A potential flat portion near 4.2 V in a charging voltage curve for a layer containing a positive electrode active material is caused by a structural phase transition of the positive electrode active material. In a positive electrode active material which is unlikely to cause this structural phase transition, a lattice parameter change cannot be reduced and a change in volume of positive electrode active material particles grows. For this reason, positive electrode active material particles are likely to crack due to the change in volume. In the conventional art, a positive electrode active material which is unlikely to cause a structural phase transition is used. Therefore, in a case where a secondary battery is repeatedly charged and discharged, particles of the positive electrode active material are likely to crack due to the change in volume. As a result, capacity deterioration is caused.

Therefore, in the present embodiment, the cracking of the particles of the positive electrode active material due to a change in volume is suppressed by increasing the specific capacity of the potential flat portion near 4.2 V in the charging voltage curve for the upper layer 54B until it exceeds 17 mAh/g so that the above-described structural phase transition is likely to occur. Accordingly, the capacity deterioration caused by the cracking of particles when the secondary battery including the positive electrode 50 according to the present embodiment is repeatedly charged and discharged can be suppressed.

On the other hand, continuation of an internal short circuit can be suppressed by allowing a core material to be easily fused due to heat generated near the core material even in a case where a large internal short circuit occurs such as when a metallic article penetrates an electrode body of the secondary battery including the positive electrode 50 according to the present embodiment, by making the specific capacity of the potential flat portion near 4.2 V in the charging voltage curve for the lower layer 54A smaller than that of the upper layer 54B. That is, the internal short circuit resistance of the secondary battery including the positive electrode 50 according to the present embodiment can be enhanced.

From the viewpoint of higher capacity degradation resistance, the specific capacity of the above-described potential flat portion of the upper layer 54B is desirably 20 mAh/g or more, more desirably 22 mAh/g or more, still more desirably 24 mAh/g or more, and most desirably 26 mAh/g or more. On the other hand, the specific capacity of the above-described potential flat portion of the upper layer 54B is desirably 30 mAh/g or less and more desirably 28 mAh/g or less.

From the viewpoint of higher internal short circuit resistance, the specific capacity of the above-described potential flat portion of the lower layer 54A is desirably 16 mAh/g or less and more desirably 15 mAh/g or less. On the other hand, the specific capacity of the above-described potential flat portion of the lower layer 54A is desirably 5 mAh/g or more, more desirably 8 mAh/g or more, still more desirably 10 mAh/g or more, and most desirably 12 mAh/g or more.

The specific capacity of the potential flat portions near 4.2 V for the entire positive electrode active material layer 54 is not particularly limited, but is desirably 18 mAh/g or more, more desirably 20 mAh/g or more, and still more desirably 22 mAh/g or more.

Specific capacities of potential flat portions near 4.2 V in charging voltage curves for the upper layer 54B, the lower layer 54A, and the entire positive electrode active material layer 54 can be determined by: manufacturing a half-cell including a positive electrode in which only the same positive electrode active material as that contained in each layer is used and a counter electrode as Li metal according to a well-known method; and measuring the charging voltage curves thereof

Specifically, for example, a positive electrode in which only the same positive electrode active material as that contained in each layer is used is produced, and a half-cell in which a counter electrode is Li metal is produced using the positive electrode as a test cell. As an electrolytic solution, for example, one obtained by dissolving LiPF₆ as a supporting salt at a concentration of 1.1 mol/L in a mixed solvent containing ethylene carbonate (EC), dimethyl carbonate (DMC), and ethyl methyl carbonate (EMC) at a volume ratio of EC:DMC:EMC=3:3:4, and further dissolving vinylene carbonate (VC) therein at a concentration of 2 mass % is used.

A charging voltage curve can be obtained by charging the test cell with a well-known charge/discharge test device at a current value of 0.05 C and graphing a voltage (V) of the cell with respect to a specific capacity (mAh/g) of the cell with the longitudinal axis being the specific capacity (mAh/g) and the lateral axis being the voltage (V). In this charging voltage curve, in a case where a structural phase transition of a positive electrode active material occurs when viewed in a direction in which the specific capacity increases, the inclination of the charging voltage curve near a voltage 4.2 V becomes small, and then becomes large thereafter. The portion where the inclination of this charging voltage curve becomes small is a potential flat portion (refer to FIGS. 2 to 6). A voltage at the center of this potential flat portion is set to Vₒ, and a specific capacity within a range of V₀±0.02 V (that is, a difference between a specific capacity value (mAh/g) at V₀+0.02 V and a specific capacity value (mAh/g) at V₀−0.02 V) can be determined as a specific capacity (mAh/g) of the potential flat portion.

Here, the specific capacity of the potential flat portion near 4.2 V at the charging voltage curve depends on the type of positive electrode active material and also depends on a mixed ratio of positive electrode active materials when two or more kinds of positive electrode active materials are mixed with each other. Accordingly, in a case where it is difficult to divide the positive electrode active material layer 54 into the upper layer 54B and the lower layer 54A for measurement, specific capacities of potential flat portions of the upper layer 54B and the lower layer 54A can be determined as follows.

The composition of the positive electrode active material layer 54 is analyzed at regular intervals (for example, every 5% of the thickness of the positive electrode active material layer 54) in a thickness direction thereof, and the presence of the upper layer 54B and the lower layer 54A is grasped from the change in the composition. Then, an average value of the compositions of the layer grasped as the upper layer 54B which are analyzed in the thickness direction is determined and used as the composition of the upper layer 54B. Similarly, an average value of the compositions of the layer grasped as the lower layer 54A which are analyzed in the thickness direction is determined and used as the composition of the lower layer 54A. A positive electrode active material layer which is a single layer having the same composition as that of this upper layer 54B is produced, a charging voltage curve for a test cell in which this positive electrode active material layer is used is created, and a specific capacity of the above-described potential flat portion is determined. Similarly, a positive electrode active material layer which is a single layer having the same composition as that of this lower layer 54A is produced, a charging voltage curve for a test cell in which this positive electrode active material layer is used is created, and a specific capacity of the above-described potential flat portion is determined.

Here, in order to obtain a sufficient effect of suppressing capacity deterioration due to the upper layer 54B, the proportion of the thickness of the upper layer 54B to the total thickness of the upper layer 54B and the lower layer 54A is 0.20 or more. From the viewpoint of a higher effect of suppressing capacity deterioration, the thickness proportion is desirably 0.23 or more and more desirably 0.25 or more.

On the other hand, in order to obtain a sufficient effect of improving internal short circuit resistance due to the lower layer 54A, the proportion of the thickness of the upper layer 54B to the total thickness of the upper layer 54B and the lower layer 54A is 0.80 or less. From the viewpoint of the higher effect of improving internal short circuit resistance (particularly higher effects of suppressing heat generation and suppressing gas generation during an internal short circuit), the thickness proportion is desirably 0.70 or less, more desirably 0.60 or less, still more desirably 0.50 or less, and most desirably 0.35 or less.

The total thickness of the positive electrode active material layer 54 is not particularly limited, but is, for example, 10 μm or more and 300 μm or less and desirably 20 μm or more and 200 μm or less.

The positive electrode active material layer 54, that is, each of the lower layer 54A and the upper layer 54B contains a positive electrode active material. As described above, a potential flat portion near 4.2 V in a charging voltage curve is caused by a structural phase transition of a positive electrode active material. Accordingly, a positive electrode active material resulting a specific capacity of the above-described potential flat portion of 2 mAh/g or more and 17 mAh/g or less is used as the positive electrode active material contained in the lower layer 54A, and a positive electrode active material resulting a specific capacity of the above-described potential flat portion of greater than 17 mAh/g and at most 30 mAh/g is used as the positive electrode active material contained in the upper layer 54B.

The positive electrode active material for the lower layer 54A and the upper layer 54B are desirably lithium composite oxides (hereinafter, also referred to as high-Ni-content lithium composite oxides) having a content of Ni of 75 mol % or more with respect to metal atoms other than lithium. In this case, it is easy to adjust the specific capacity of the potential flat portion near 4.2 V in the charging voltage curve and is possible to increase the capacity of the positive electrode 50. The high-Ni-content lithium composite oxides desirably have a layered rock salt type crystal structure. The content of Ni with respect to metal atoms other than lithium in the high-Ni-content lithium composite oxide is desirably 75 mol % or more and 95 mol % or less.

Examples of high-Ni-content lithium composite oxides include a lithium-nickel-cobalt-manganese composite oxide and a lithium-nickel-cobalt-aluminum composite oxide. It should be noted that the term “lithium-nickel-cobalt-manganese composite oxide” in the present specification is a term including not only an oxide containing Li, Ni, Co, Mn, and O as constituent elements but also an oxide further containing one or two or more kinds of other additive elements. Similarly, the term “lithium-nickel-cobalt-aluminum composite oxide” in the present specification is a term including not only an oxide containing Li, Ni, Co, Al, and O as constituent elements but also an oxide further containing one or two or more kinds of other additive elements.

A lithium-nickel-cobalt-manganese composite oxide is desirable as the high-Ni-content lithium composite oxide. In the lithium-nickel-cobalt-manganese composite oxide, the content of Ni with respect to metal atoms other than Li is 75 mol % or more as described above. The content of Co is not particularly limited but is desirably 2 mol % or more and more desirably 5 mol % or more. The content of Mn is not particularly limited but is desirably 2 mol % or more and more desirably 5 mol % or more.

Examples of methods for controlling the specific capacity of the above-described potential flat portion include: a method of using a positive electrode active material with which an appropriate additive element is doped; and a method of using a positive electrode active material in which a compound (particularly, an oxide) containing an appropriate additive element is adhered to its surface (particularly, coats its surface). The above-described specific capacity can be changed by appropriately selecting the types and amounts of an additive element added.

Specifically, the specific capacity of the above-described potential flat portion of the upper layer 54B can be easily adjusted to a range of greater than 17 mAh/g and at most 30 mAh/g by using, for example, a positive electrode active material (particularly, a high-Ni-content lithium composite oxide) with which an additive element such as W and Zr are doped, as the positive electrode active material of the upper layer 54B. Alternatively, the specific capacity of the above-described potential flat portion of the upper layer 54B can be easily adjusted to a range of greater than 17 mAh/g and at most 30 mAh/g by using a positive electrode active material (particularly, a high-Ni-content lithium composite oxide) in which a compound (particularly, an oxide) containing W, Zr, and the like is adhered to its surface, as the positive electrode active material of the upper layer 54B. The amount of the additive element may be appropriately set, and is, for example, 0.1 mol % or more and 1.0 mol % or less and desirably 0.2 mol % or more and 0.7 mol % or less with respect to the high-Ni-content lithium composite oxide.

Specifically, the specific capacity of the above-described potential flat portion of the lower layer 54A can be easily adjusted to a range of 2 mAh/g or more and 17 mAh/g or less by using, for example, a positive electrode active material (particularly, a high-Ni-content lithium composite oxide) with which an additive element such as Ti and Nb are doped, as the positive electrode active material of the lower layer 54A. Alternatively, the specific capacity of the above-described potential flat portion of the lower layer 54A can be easily adjusted to a range of 2 mAh/g or more and 17 mAh/g or less by using a positive electrode active material (particularly, a high-Ni-content lithium composite oxide) in which a compound (particularly, an oxide) containing Ti, Nb, and the like is adhered to its surface, as the positive electrode active material of the lower layer 54A. The amount of the additive element may be appropriately set, and is, for example, 1.0 mol % or more and 10 mol % or less and desirably 2.0 mol % or more and 5.0 mol % or less with respect to the high-Ni-content lithium composite oxide.

It should be noted that the specific capacity value of the above-described potential flat portion can change even in a state where a mixed phase is formed in a positive electrode active material with which an additive element is excessively doped.

In addition, the specific capacity can be adjusted using a mixture of two or more kinds of positive electrode active materials having different compositions.

Examples of another method for controlling the above-described specific capacity include a method of using a positive electrode active material in a form of single particles. Specifically, in a case where a positive electrode active material in a form of single particles is used, a specific capacity of a positive electrode active material layer increases. Accordingly, the specific capacity of the above-described potential flat portion of the upper layer 54B can be easily adjusted to a range of greater than 17 mAh/g and at most 30 mAh/g by using, for example, a positive electrode active material in a form of single particles (particularly, a single-particle-like high-Ni-content lithium composite oxide) as the positive electrode active material of the upper layer 54B. In addition, the positive electrode active material in a form of single particles is unlikely to cause cracking of particles, and therefore, capacity deterioration caused by cracking of particles can be further suppressed. The proportion of the positive electrode active material in a form of single particles in the positive electrode active material of the upper layer 54B is desirably 20 mass % or more and more desirably 40 mass % or more. On the other hand, in a case where a positive electrode active material in a form of single particles (particularly, a single-particle-like high-Ni-content lithium composite oxide) is used in combination as the positive electrode active material of the lower layer 54A, occurrence of cracking of the positive electrode active material particles in the lower layer 54A can be reduced.

It should be noted that in general, a positive electrode active material is in the form of secondary particles in which primary particles are aggregated. In contrast, “single particle” is a particle generated by growth of a single crystal nucleus, and is therefore a monocrystalline particle that does not contain a crystal grain boundary. The fact that a particle is a monocrystal can be confirmed, for example, by analyzing an electron beam diffraction image with a transmission electron microscope (TEM).

A single particle can independently form a positive electrode active material particle, but single particles may aggregate to form a positive electrode active material particle. However, in the case where single particles aggregate to form a positive electrode active material particle, the number of single particles aggregating is 2 or more and 10 or less. Accordingly, one positive electrode active material particle is composed of one or more and ten or less single particles. A positive electrode active material particle can be composed of one or more and five or less single particles, one or more and three or less single particles, and one single particle. The number of single particles in one positive electrode active material particle can be confirmed through observation using a scanning electron microscope (SEM) at a magnification of 10,000 times to 30,000 times.

As described above, single particles are different from secondary particles in which a large number (for example, 11 or more) of fine particles (primary particles) or polycrystalline particles consisting of a plurality of crystal grains aggregate. A positive electrode active material in a form of single particles can be produced according to a well-known method (for example, a molten salt method) for obtaining single crystal particles.

In addition, a single particle is usually larger than a primary particle in a case where a primary particle constituting a secondary particle is a single crystal body. For this reason, single particles are difficult to aggregate. The maximum diameter of a single particle may be 0.5 μm or more, may be greater than 1 μm, may be greater than 2 μm, or may be 3 μm or more and 7 μm or less. In addition, the average maximum diameter of single particles may be 3 μm or more and 7 μm or less. It should be noted that the maximum diameter of a single particle can be determined as a distance between two farthest points on a contour line of the single particle in an SEM image of the single particle. This SEM image may be a two-dimensional projection image of a single particle, or may be a cross-sectional image thereof. The average maximum diameter of single particles can be determined as an average value of maximum diameters of arbitrarily selected 100 or more single particles in the SEM image.

The shape of single particle is not particularly limited, and may be spherical, columnar, plate-shaped, or amorphous.

In addition, the specific capacity can be adjusted using a secondary-particle-like positive electrode active material and a single-particle-like positive electrode active material in combination.

As examples, FIGS. 2 to 6 show charging voltage curves of half-cells in the case where each positive electrode active material layer containing a positive electrode active material below is used as a positive electrode and Li metal is used as a counter electrode.

FIG. 2: Secondary-particle-like positive electrode active material in which 0.5 atomic % of ZrO₂ is added to LiNi_{0.8}Co_{0.1}Mn_{0.1}O₂

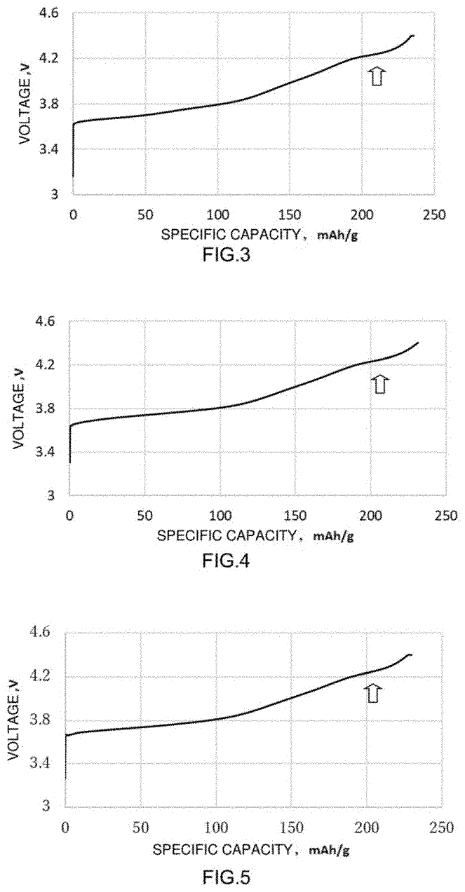

FIG. 3: Secondary-particle-like positive electrode active material in which 0.5 atomic % of WO₃ is added to LiNi_{0.8}Co_{0.1}Mn_{0.1}O₂

FIG. 4: Secondary-particle-like positive electrode active material in which 3 atomic % of TiO₂ is added to LiNi_{0.8}Co_{0.1}Mn_{0.1}O₂

FIG. 5: Secondary-particle-like positive electrode active material in which 1 atomic % of Nb₂O₅ is added to LiNi_{0.8}Co_{0.1}Mn_{0.1}O₂

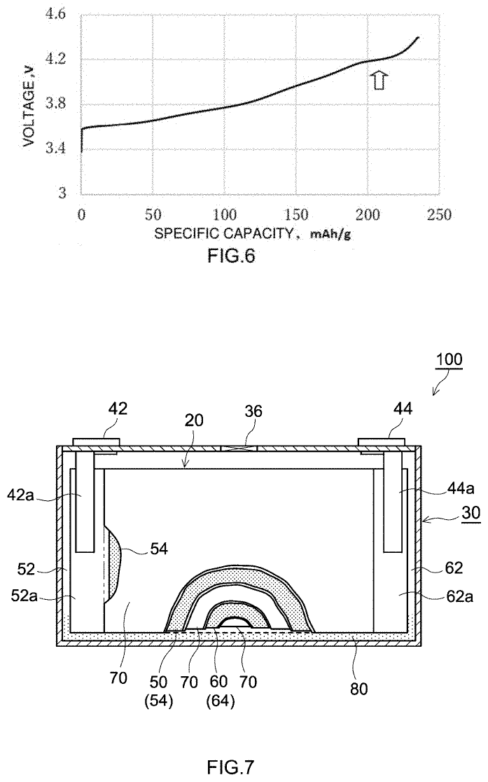

FIG. 6: Positive electrode active material which is single-particle-like LiNi_{0.8}Co_{0.1}Mnₒ₁O₂

In FIGS. 2 to 6, after the inclination of each graph near a voltage of 3.8 V becomes large, the inclination of each graph near 4.2 V becomes small, and then, the inclination of each graph becomes large. The portion where the inclination of each graph near 4.2 V becomes small is a potential flat portion (refer to arrows in FIGS. 2 to 6).

The content of a positive electrode active material in the positive electrode active material layer 54 is not particularly limited. The content of a positive electrode active material in the positive electrode active material layer 54 (that is, with respect to the total mass of the positive electrode active material layer 54) is desirably 70 mass % or more, more desirably 80 mass % or more, and still more desirably 85 mass % or more.

The average particle diameter (median diameter D50) of a positive electrode active material is not particularly limited. In a case where a positive electrode active material is in the form of secondary particles, the average particle diameter (median diameter D50) thereof is, for example, 0.05 μm or more and 25 μm or less, desirably 10 μm or more and 25 μm or less. In a case where a positive electrode active material is in the form of single particles, the average particle diameter thereof is desirably 2 μm or more and 5 μm or less. It should be noted that the average particle diameter (median diameter D50) of a positive electrode active material can be determined, for example, by a laser diffraction-scattering method.

The positive electrode active material layer 54 may contain components other than the positive electrode active material. Examples thereof include lithium phosphate (Li₃PO₄), a conductive material, and a binder.

The content of lithium phosphate in the positive electrode active material layer 54 is not particularly limited, but is desirably 1 mass % or more and 15 mass % or less and more desirably 2 mass % or more and 12 mass % or less.

As a conductive material, carbon black such as acetylene black (AB) or other carbon materials (for example, graphite) may be suitably used, for example. The content of a conductive material in the positive electrode active material layer 54 is not particularly limited, but is, for example, 0.1 mass % or more and 20 mass % or less, desirably 1 mass % or more and 15 mass % or less, and more desirably 2 mass % or more and 10 mass % or less.

As a binder, polyvinylidene fluoride (PVdF) may be used, for example. The content of a binder in the positive electrode active material layer 54 is not particularly limited, but is, for example, 0.5 mass % or more and 15 mass % or less, desirably 1 mass % or more and 10 mass % or less, and more desirably 1.5 mass % or more and 8 mass % or less.

The positive electrode 50 can be produced according to a well-known method.

According to the positive electrode configured as described above, it is possible to impart excellent cycle characteristics and internal short circuit resistance to a secondary battery. Accordingly, the positive electrode disclosed herein is suitably for secondary batteries and more suitably for lithium ion secondary batteries.

Secondary Battery

From another aspect, a secondary battery disclosed herein includes: the above-described positive electrode; a negative electrode; and an electrolyte.

Hereinafter, one embodiment of a secondary battery disclosed herein will be described in detail by taking a flat rectangular lithium ion secondary battery having a flat-shaped wound electrode body and a flat-shaped battery case as an example, but the secondary battery disclosed herein is not intended to be limited to that described in the embodiment.

The lithium ion secondary battery 100 shown in FIG. 7 is a sealed battery constructed by accommodating a flat-shaped wound electrode body 20 and a non-aqueous electrolyte 80 in a flat rectangular battery case (that is, an outer container) 30. The battery case 30 is provided with a positive electrode terminal 42 and a negative electrode terminal 44 for external connection, and a thin safety valve 36 which is set to release the internal pressure of the battery case 30 in a case where the internal pressure rises to or above a predetermined level. In addition, the battery case 30 is provided with an injection port (not shown in the drawing) for injecting the non-aqueous electrolyte 80. The positive electrode terminal 42 and the positive electrode current collector plate 42a are electrically connected to each other. The negative electrode terminal 44 and the negative electrode current collector plate 44a are electrically connected to each other. For example, lightweight metallic materials, such as aluminum, having favorable thermal conductivity are used as material of the battery case 30. FIG. 7 does not accurately represent the amount of non-aqueous electrolyte 80.

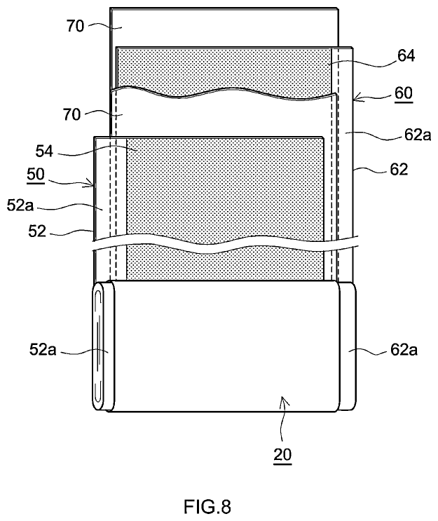

As shown in FIGS. 7 and 8, the wound electrode body 20 has a form in which a positive electrode sheet 50 and a negative electrode sheet 60 overlap via two long separator sheets 70 and are wound in a longitudinal direction. The positive electrode sheet 50 has a configuration in which a positive electrode active material layer 54 is formed on a single surface or both surfaces (here, both surfaces) of a long positive electrode current collector 52 along the longitudinal direction. The negative electrode sheet 60 has a configuration in which a negative electrode active material layer 64 is formed on a single surface or both surfaces (here, both surfaces) of a long negative electrode current collector 62 along the longitudinal direction. A positive electrode active material layer non-formed portion 52a (that is a portion in which the positive electrode active material layer 54 is not formed and the positive electrode current collector 52 is exposed) and a negative electrode active material layer non-formed portion 62a (that is, a portion in which the negative electrode active material layer 64 is not formed and the negative electrode current collector 62 is exposed) are formed so as to protrude outward from both ends of the wound electrode body 20 in a winding axis direction (that is a sheet width direction orthogonal to the above-described longitudinal direction). A positive electrode current collector plate 42a and a negative electrode current collector plate 44a are respectively joined to the positive electrode active material layer non-formed portion 52a and the negative electrode active material layer non-formed portion 62a.

The above-described positive electrode is used for the positive electrode sheet 50.

On the other hand, as the negative electrode current collector 62 constituting the negative electrode sheet 60, a foil-like or sheet-like body made of a metal such as copper, nickel, titanium, or stainless steel can be used, and copper foil is desirably used. When the copper foil is used as the negative electrode current collector 62, the thickness thereof is not particularly limited, but is, for example, 5 μm or more and 35 μm or less and desirably 7 μm or more and 20 μm or less.

As a negative electrode active material, a well-known negative electrode active material used in lithium ion secondary batteries can be used, and for example, carbon materials such as graphite, hard carbon, or soft carbon can be used. Graphite may be natural graphite or artificial graphite, or may be amorphous carbon-coated graphite in which graphite is coated with an amorphous carbon material.

The content of a negative electrode active material in a negative electrode active material layer is not particularly limited but is desirably 90 mass % or more and more desirably 95 mass % or more.

The negative electrode active material layer 64 may contain components other than the negative electrode active material, for example, a binder or a thickener.

As a binder, styrene-butadiene rubber (SBR) and its modified products, acrylonitrile-butadiene rubber and its modified products, acrylic rubber and its modified products, and fluororubber can be used, for example. Among these, SBR is desirable. The content of a binder in the negative electrode active material layer 64 is not particularly limited, but is desirably 0.1 mass % or more and 8 mass % or less and more desirably 0.2 mass % or more and 3 mass % or less.

As a thickener, cellulosic polymers such as carboxymethyl cellulose (CMC), methyl cellulose (MC), cellulose acetate phthalate (CAP), hydroxypropyl methylcellulose (HPMC); and polyvinyl alcohol (PVA) can be used, for example. Among these, CMC is desirable. The content of a thickener in the negative electrode active material layer 64 is not particularly limited, but is desirably 0.3 mass % or more and 3 mass % or less and more desirably 0.4 mass % or more and 2 mass % or less.

The thickness of the negative electrode active material layer 64 is not particularly limited, but is, for example, 10 μm or more and 300 μm or less and desirably 20 μm or more and 200 μm or less.

Examples of the separator 70 include porous sheets (films) made of resins such as polyethylene (PE), polypropylene (PP), polyester, cellulose, and polyamide. Such porous sheets may have a single-layer structure or a structure in which two or more layers are stacked (for example, three-layer structure in which PP layers are stacked on both surfaces of a PE layer). A heat resistant layer (HRL) may be provided on the surface of the separator 70.

The thickness of the separator 70 is not particularly limited, but is, for example, 5 μm or more and 50 μm or less and desirably 10 μm or more and 30 μm or less.

The non-aqueous electrolyte 80 typically contains a non-aqueous solvent and an electrolyte salt (in other words, a supporting salt). Various organic solvents such as carbonates, ethers, esters, nitriles, sulfones, and lactones, which are used in electrolytes of general lithium ion secondary batteries, can be used as non-aqueous solvents without particular limitation. Among these, carbonates are desirable, and specific examples thereof include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), and trifluorodimethyl carbonate (TFDMC). Such non-aqueous solvents can be used alone or in combination of two or more thereof

As electrolyte salts, lithium salts such as LiPF₆, LiBF₄, and lithium bis(fluorosulfonyl)imide (LiFSI) can be used, for example, and among these, LiPF₆ is desirable. The concentration of electrolyte salts is not particularly limited, but is desirably 0.7 mol/L or more and 1.3 mol/L or less.

The above-described non-aqueous electrolyte 80 may contain components other than the above-described components: for example, various additives, e.g., film forming agents such as an oxalate complex and vinylene carbonate (VC); gas generators such as biphenyl (BP) and cyclohexylbenzene (CHB); and thickeners as long as the effects of the present disclosure are not significantly impaired.

In the lithium ion secondary battery 100 configured as described above, capacity deterioration when charging and discharging are repeated is suppressed. That is, the lithium ion secondary battery 100 has excellent cycle characteristics. In addition, the lithium ion secondary battery 100 generates less heat in a case where a large internal short circuit occurs such as when a metallic article penetrates an electrode body. That is, the lithium ion secondary battery 100 has excellent internal short circuit resistance.

The lithium ion secondary battery 100 can be used for various applications. Examples of suitable applications include drive power sources mounted in vehicles such as battery-powered electric vehicles (BEV), hybrid electric vehicles (HEV), and plug-in hybrid electric vehicles (PHEV). In addition, the lithium ion secondary battery 100 can be used as a storage battery for a small power storage device, and the like. The lithium ion secondary battery 100 can also be typically used in the form of a battery pack in which a plurality of lithium ion secondary batteries are connected in series and/or in parallel.

It should be noted that the rectangular lithium ion secondary battery 100 including the flat-shaped wound electrode body 20 was described as an example. However, the lithium ion secondary battery disclosed herein can also be configured as a lithium ion secondary battery including a stacked type electrode body (that is, an electrode body in which a plurality of positive electrodes and a plurality of negative electrodes are alternately laminated). In addition, the non-aqueous electrolyte secondary battery disclosed herein can also be configured as a cylindrical lithium ion secondary battery, a laminate-cased lithium ion secondary battery, a coin type lithium ion secondary battery, or the like.

In addition, a non-aqueous electrolyte secondary battery other than the lithium ion secondary battery can also be constructed using the above-described positive electrode according to a well-known method. Furthermore, an all-solid secondary battery (particularly, an all-solid lithium ion secondary battery) can be constructed using a solid electrolyte instead of the non-aqueous electrolyte 80 according to a well-known method.

Hereinafter, examples of the present disclosure will be described, but the present disclosure is not intended to be limited to those shown in such examples.

### EXAMPLE 1

As a positive electrode active material for a lower layer, a lithium-nickel-cobalt-manganese composite oxide (NCM811-Ti) in which LiNi_{0.8}Co_{0.1}Mn_{0.1}O₂ was doped with 3 mol % Ti was prepared. This lithium-nickel-cobalt-manganese composite oxide was in the form of secondary particles. A positive electrode active material for a lower layer, acetylene black (AB) as a conductive material, a polyvinylidene fluoride (PVDF) as a binder were mixed at a mass ratio of positive electrode active material for lower layer:AB:PVDF=97.5:1.5:1.0, and an appropriate amount of N-methyl-2-pyrrolidone (NMP) was added to the obtained mixture to prepare a slurry for forming a lower layer.

As a positive electrode active material for an upper layer, a lithium-nickel-cobalt-manganese composite oxide (NCM811-Zr) in which LiNi_{0.8}Co_{0.1}Mn_{0.1}O₂ was doped with 0.3 mol % Zr was prepared. This lithium-nickel-cobalt-manganese composite oxide was in the form of secondary particles. A positive electrode active material for an upper layer, acetylene black (AB) as a conductive material, a polyvinylidene fluoride (PVDF) as a binder were mixed at a mass ratio of positive electrode active material for upper layer:AB:PVDF=97.5:1.5:1.0, and an appropriate amount of N-methyl-2-pyrrolidone (NMP) was added to the obtained mixture to prepare a slurry for forming an upper layer.

The slurry for forming a lower layer was applied to both surfaces of a positive electrode current collector made of aluminum foil having a thickness of 15 μm, and dried. Next, the slurry for forming an upper layer was applied to the dried coating film of the slurry for forming a lower layer, and dried. At this time, the thickness of the coating film of the slurry for forming a lower layer was the same as that of the coating film of the slurry for forming an upper layer. Thereafter, the coating film was roll-pressed with a rolling roller to produce a positive electrode sheet. In the positive electrode active material layer after the roll pressing, the thickness of the lower layer formed by the slurry for forming a lower layer was the same as that of the upper layer formed by the slurry for forming an upper layer. The dimension of the produced positive electrode was 6150 mm long×117 mm wide×120 μm thick.

In addition, graphite (C) as a negative electrode active material, styrene butadiene rubber (SBR) as a binder, and carboxymethyl cellulose (CMC) as a thickener were mixed in an ion exchange water at a mass ratio of C:SBR:CMC=98:1:1 to prepare a slurry for forming a negative electrode active material layer. This slurry for forming a negative electrode active material layer was applied to copper foil having a thickness of 10 μm. Thereafter, the slurry was dried and roll-pressed to a predetermined thickness to produce a negative electrode sheet. The dimension of the produced negative electrode was 6300 mm long×122 mm wide×130 μm thick.

A porous polyolefin sheet having a three-layer structure of PP/PE/PE and a thickness of 24 μm was prepared as a separator. A laminate was obtained by superposing the positive electrode sheet and the negative electrode sheet via the separator. Next, the laminate was wound to obtain a wound body, which was pressed so as to have a flat shape to obtain a flat-shaped wound electrode body.

Electrode terminals were attached to the electrode body, and this was inserted into a battery case, welded, and then a non-aqueous electrolyte was injected. As a non-aqueous electrolyte, one obtained by dissolving LiPF₆ as a supporting salt at a concentration of 1.1 mol/L in a mixed solvent containing ethylene carbonate (EC), dimethyl carbonate (DMC), and ethyl methyl carbonate (EMC) at a volume ratio of EC:DMC:EMC=3:3:4, and further dissolving vinylene carbonate (VC) therein at a concentration of 2 mass % was used. Thereafter, a lithium ion secondary battery for evaluation of Example 1 was obtained by sealing the battery case.

### EXAMPLE 2

A lithium ion secondary battery for evaluation of Example 2 was obtained in the same manner as in Example 1 except that a mixed active material in which single-particle-like LiNi_{0.8}Co_{0.1}Mn_{0.1}O₂ was mixed with a lithium-nickel-manganese-cobalt composite oxide (in the form of secondary particles) in which LiNi_{0.8}Co_{0.1}Mn_{0.1}O₂ was doped with 3 mol % Ti at a mass ratio of 50:50 was used as a positive electrode active material for a lower layer.

### EXAMPLE 3

A lithium ion secondary battery for evaluation of Example 3 was obtained in the same manner as in Example 1 except that single-particle-like LiNi_{0.8}Co_{0.1}Mn_{0.1}O₂ (NCM811) was used as a positive electrode active material for an upper layer, a mixed active material in which single-particle-like LiNi_{0.8}Co_{0.1}Mn_{0.1}O₂ was mixed with a lithium-nickel-manganese-cobalt composite oxide (in the form of secondary particles) in which LiNi_{0.8}Co_{0.1}Mn_{0.1}O₂ was doped with 3 mol % Ti at a mass ratio of 50:50 was used as a positive electrode active material for a lower layer, and the thickness ratio between the upper layer and the lower layer was changed to 25:75.

### EXAMPLES 4 TO 7

Lithium ion secondary batteries for evaluation of Examples 4 to 7 were obtained in the same manner as in Example 1 except that a mixed active material in which single-particle-like LiNi_{0.8}Co_{0.1}Mn_{0.1}O₂ was mixed with a lithium-nickel-manganese-cobalt composite oxide (in the form of secondary particles) in which LiNi_{0.8}Co_{0.1}Mn _{0.1}O₂ was doped with 0.3 mol % Zr at a mass ratio of 50:50 was used as a positive electrode active material for an upper layer, a mixed active material in which single-particle-like LiNi_{0.8}Co _{0.1}Mn_{0.1}O₂ was mixed with a lithium-nickel-manganese-cobalt composite oxide (in the form of secondary particles) in which LiNi_{0.1}Co_{0.1}Mn_{0.1}O₂ was doped with 3 mol % Ti at a mass ratio of 50:50 was used as a positive electrode active material for a lower layer, and the thickness ratio between the upper layer and the lower layer was changed to values shown in Table 1.

### COMPARATIVE EXAMPLE 1

A lithium ion secondary battery for evaluation of Comparative Example 1 was obtained in the same manner as in Example 1 except that a positive electrode having the same thickness of the positive electrode in Example 1 was produced using only the slurry for forming a lower layer produced in Example 1.

### COMPARATIVE EXAMPLE 2

A lithium ion secondary battery for evaluation of Comparative Example 2 was obtained in the same manner as in Example 1 except that a positive electrode having the same thickness of the positive electrode in Example 1 was produced using only the slurry for forming an upper layer produced in Example 1.

### COMPARATIVE EXAMPLE 3

A lithium ion secondary battery for evaluation of Comparative Example 3 was obtained in the same manner as in Example 1 except that the upper layer of the positive electrode active material layer was exchanged with the lower layer thereof by reversing the order of applying the slurry for forming a lower layer and the slurry for forming an upper layer.

### COMPARATIVE EXAMPLE 4

A lithium ion secondary battery for evaluation of Comparative Example 4 was obtained in the same manner as in Example 1 except that a positive electrode having the same thickness of the positive electrode in Example 1 was produced using only the slurry for forming a lower layer produced in Example 2.

### COMPARATIVE EXAMPLE 5

A lithium ion secondary battery for evaluation of Comparative Example 5 was obtained in the same manner as in Comparative Example 4 except that the mass ratio between the single-particle-like LiNi_{0.8}Co_{0.1}Mn_{0.1}O₂ and the lithium-nickel-manganese-cobalt composite oxide (in the form of secondary particles) in which LiNi_{0.8}Co_{0.1}Mn_{0.1}O₂ was doped with 3 mol % Ti was changed to 25:75.

Measurement of Specific Capacity of Potential Flat Portion

Each positive electrode including a positive electrode active material layer having the same composition as Comparative Examples 1, 2, 4, and 5, and each positive electrode including a positive electrode active material layer having the same composition as the upper layers and the lower layers of Comparative Example 3 and the Examples were produced. Using Li negative electrodes and these positive electrodes, test lithium ion secondary batteries were produced in the same manner as in Example 1 (that is, using the same non-aqueous electrolytic solution). A charging voltage curve was obtained by charging each test lithium ion secondary battery with a commercially available charge/discharge test device at a current value of 0.05 C, and graphing a voltage (V) of the cell with respect to a specific capacity (mAh/g) of the cell with the longitudinal axis being the specific capacity (mAh/g) and the lateral axis being the voltage (V). A voltage at the center of the potential flat portion near a voltage of 4.2 V in the charging voltage curve is set to V₀, and a specific capacity within a range of V₀±0.02 V (that is, a difference between a specific capacity value (mAh/g) at V₀+0.02 V and a specific capacity value (mAh/g) at V₀−0.02 V) was determined as a specific capacity (mAh/g) of the potential flat portion. The results are shown in Table 1.

Fusing Test

Each lithium ion secondary battery for evaluation was charged with a constant current up to 4.2 V. A nail (manufactured by Daidohant Co., Ltd., a round nail, a diameter of the body of 3 mm) was stuck into the center portion of a battery case so as to penetrate a positive electrode and a negative electrode in a thickness direction of each lithium ion secondary battery for evaluation while measuring the voltage with a data logger, and thereby an internal short circuit was generated. Since a voltage rise after a voltage drop is due to Joule heat caused by an internal short circuit, a calorific value (J) was calculated during the voltage rise using a voltage, a current, and a time. The results are shown in Table 1.

Evaluation of Cycle Characteristics

Each lithium ion secondary battery for evaluation was charged with a constant current of 0.1 C up to 4.2 V, and then, discharged with a constant current of 0.1 C up to 2.5 V, at a room temperature. The discharge capacity at this time was determined and defined as an initial capacity.

Each lithium ion secondary battery for evaluation was placed at 25° C., and 500 cycles of charging and discharging were performed therewith in which one cycle of charging and discharging included charging with a constant current of 2 C up to 4.2 V, pause for 10 minutes, discharging with a constant current of 2 C up to 3.0 V, and pause for 10 minutes. The discharge capacity after 500 cycles was determined through the same method as that of determining an initial capacity. A capacity retention rate (%) was determined from (discharge capacity after 500 cycles of charging and discharging/initial capacity)×100. The results are shown in Table 1.

TABLE 1

| | Upper layer | | | Lower layer | | | | | |
|---|---|---|---|---|---|---|---|---|---|
| | | | Specific | | | Specific | | | |
| | | | capacity | | | capacity | Thickness | | |
| | | | of | | | of | ratio of | | |
| | | Mixed | potential | | Mixed | potential | upper | Amount | |
| | | ratio of | flat | | ratio of | flat | layer/(upper | of heat | Capacity |
| | Active | single | portion | Active | single | portion | layer + lower | generated | retention |
| | material | particles | (mAh/g) | material | particles | (mAh/g) | layer) | (J) | rate (%) |
| Comparative | NCM811- | 0% | 2.2 | — | — | — | 0 | 5.9 | 55.7 |
| Example 1 | Ti | | | | | | | | |
| | (secondary | | | | | | | | |
| | particle) | | | | | | | | |
| Comparative | NCM811- | 0% | 27.4 | — | — | — | 0 | 4.8 | 70.2 |
| Example 2 | Zr | | | | | | | | |
| | (secondary | | | | | | | | |
| | particle) | | | | | | | | |
| Comparative | NCM811- | 0% | 2.2 | NCM811- | 0% | 27.4 | 0.5 | 4.3 | 50.4 |
| Example 3 | Ti | | | Zr | | | | | |
| | (secondary | | | (secondary | | | | | |
| | particle) | | | particle) | | | | | |
| Comparative | NCM811 | 50% | 14.6 | — | — | — | 0 | 1 | 68.4 |
| Example 4 | (single | | | | | | | | |
| | particle) + | | | | | | | | |
| | NCM811- | | | | | | | | |
| | Ti | | | | | | | | |
| | (secondary | | | | | | | | |
| | particle) | | | | | | | | |
| Comparative | NCM811 | 25% | 8.4 | — | — | — | 0 | 1 | 59.3 |
| Example 5 | (single | | | | | | | | |
| | particle) + | | | | | | | | |
| | NCM811- | | | | | | | | |
| | Ti | | | | | | | | |
| | (secondary | | | | | | | | |
| | particle) | | | | | | | | |
| Example 1 | NCM811- | 0% | 27.4 | NCM811- | 0% | 2.2 | 0.5 | 2.2 | 75.7 |
| | Zr | | | Ti | | | | | |
| | (secondary | | | (secondary | | | | | |
| | particle) | | | particle) | | | | | |
| Example 2 | NCM811- | 0% | 27.4 | NCM811 | 50% | 14.6 | 0.5 | 1.2 | 82.4 |
| | Zr | | | (single | | | | | |
| | (secondary | | | particle) + | | | | | |
| | particle) | | | NCM811- | | | | | |
| | | | | Ti | | | | | |
| | | | | (secondary | | | | | |
| | | | | particle) | | | | | |
| Example 3 | NCM811 | 100% | 26.8 | NCM811 | 50% | 14.6 | 0.25 | 1.1 | 87.8 |
| | (single | | | (single | | | | | |
| | particle) | | | particle) + | | | | | |
| | | | | NCM811- | | | | | |
| | | | | Ti | | | | | |
| | | | | (secondary | | | | | |
| | | | | particle) | | | | | |
| Example 4 | NCM811 | 50% | 26.5 | NCM811 | 50% | 14.6 | 0.2 | 1.5 | 79.3 |
| | (single | | | (single | | | | | |
| | particle) + | | | particle) + | | | | | |
| | NCM811- | | | NCM811- | | | | | |
| | Zr | | | Ti | | | | | |
| | (secondary | | | (secondary | | | | | |
| | particle) | | | particle) | | | | | |
| Example 5 | NCM811 | 50% | 26.5 | NCM811 | 50% | 14.6 | 0.25 | 1.2 | 87.8 |
| | (single | | | (single | | | | | |
| | particle) + | | | particle) + | | | | | |
| | NCM811- | | | NCM811- | | | | | |
| | Zr | | | Ti | | | | | |
| | (secondary | | | (secondary | | | | | |
| | particle) | | | particle) | | | | | |
| Example 6 | NCM811 | 50% | 26.5 | NCM811 | 50% | 14.6 | 0.5 | 1.4 | 85.7 |
| | (single | | | (single | | | | | |
| | particle) + | | | particle) + | | | | | |
| | NCM811- | | | NCM811- | | | | | |
| | Zr | | | Ti | | | | | |
| | (secondary | | | (secondary | | | | | |
| | particle) | | | particle) | | | | | |
| Example 7 | NCM811 | 50% | 26.5 | NCM811 | 50% | 14.6 | 0.8 | 2.9 | 93.5 |
| | (single | | | (single | | | | | |
| | particle) + | | | particle) + | | | | | |
| | NCM811- | | | NCM811- | | | | | |
| | Zr | | | Ti | | | | | |
| | (secondary | | | (secondary | | | | | |
| | particle) | | | particle) | | | | | |

The lithium ion secondary batteries of Comparative Examples 1 to 5 had a low capacity retention rate of about 50% to about 70%. The lithium ion secondary batteries of Comparative Examples 1 to 5 after the evaluation of the cycle characteristics were disassembled, and the states of positive electrode active material layers were observed. As a result, cracking of positive electrode active material particles was progressing from surface layers of the positive electrode active material layers, and the lower the capacity retention rate, the more cracks of the positive electrode active material particles occurred. In addition, the lithium ion secondary batteries of Comparative Examples 1 to 3 had a large calorific value of 4 J or larger.

On the other hand, the lithium ion secondary batteries of Examples 1 to 7 had a high capacity retention rate of 75% or higher. In addition, in the lithium ion secondary batteries of Examples 1 to 7, a small calorific value of less than 3 J could be achieved. The lithium ion secondary batteries of Examples 1 to 7 after the evaluation of the cycle characteristics were disassembled, and the states of positive electrode active material layers were observed. As a result, there were fewer cracks of the positive electrode active material particles compared with those in Comparative Examples 1 to 5, and the higher the capacity retention rate, the fewer the cracks of the positive electrode active material particles. In addition, in Example 2 in which single particles were mixed in the lower layer, there were few cracks of the positive electrode active material particles even in a lower layer compared with those in Example 1. In Examples 3 and 4 in which single particles were used in upper layers, the higher the mixed ratio of the single particles, the fewer the cracks and the higher the capacity retention rate. It can be seen from the comparison of Examples 4 to 7 that the favorable thickness ratio of the upper layer is 0.8 or less from the viewpoint of internal short circuit resistance (suppression of heat generation) and the favorable thickness ratio of the upper layer is 0.2 or more from the viewpoint of cycle characteristics.

Summing up the above-described results, in a case where the proportion of the thickness of an upper layer to the total thickness of an upper layer and a lower layer is 0.20 or more and 0.80 or less, the specific capacity of the above-described potential flat portion of an upper layer is larger than that of a lower layer, the specific capacity of the above-described potential flat portion of an upper layer is greater than 17 mAh/g and at most 30 mAh/g, and the specific capacity of the above-described potential flat portion of a lower layer is 2 mAh/g or more and 17 mAh/g or less, it can be said that the calorific value is small and the capacity retention rate is high. Accordingly, according to the positive electrode disclosed herein, it can be seen that it is possible to impart excellent cycle characteristics and internal short circuit resistance to a secondary battery.

Concrete examples of the present disclosure have been explained in detail above, but the examples are merely illustrative in nature, and are not meant to limit the scope of the claims in any way. The art set forth in the claims encompasses various alterations and modifications of the concrete examples illustrated above.

What is claimed is:

1. A positive electrode comprising:
a positive electrode current collector; and
a positive electrode active material layer provided on the positive electrode current collector, wherein
the positive electrode active material layer has a first layer located on the positive electrode current collector side and a second layer located on a surface layer side of the positive electrode active material layer,
a proportion of a thickness of the second layer to a total thickness of the first layer and the second layer is 0.20 or more and 0.80 or less,
when each specific capacity of a potential flat portion near 4.2 V (vs Li/Li⁺) in a charging voltage curve is measured for the first layer and the second layer, the specific capacity of the potential flat portion of the second layer is larger than that of the first layer,
the specific capacity of the potential flat portion of the second layer is greater than 17 mAh/g and at most 30 mAh/g, and
the specific capacity of the potential flat portion of the first layer is 2 mAh/g or more and 17 mAh/g or less.

2. The positive electrode according to claim 1, wherein
the first layer and the second layer each contain a positive electrode active material, and
each of the positive electrode active materials contained in the first layer and the second layer is lithium composite oxides having a content of Ni of 75 mol % or more with respect to metal atoms other than lithium.

3. The electrode according to claim 1, wherein the first layer contains a Ti-doped positive electrode active material, and the second layer contains a Zr-doped positive electrode active material.

4. The positive electrode according to claim 1, wherein the first layer or the second layer contains a positive electrode active material in a form of single particles.

5. The positive electrode according to claim 1, wherein the proportion of the thickness is 0.23 or more and 0.50 or less.

6. A secondary battery comprising:
the positive electrode according to claim 1;
a negative electrode; and
an electrolyte.
